(19) United States
(12) Patent Application Publication
(10) Pub. No.: US 2015/0371081 A1
(43) Pub. Date: Dec. 24, 2015

(54) INFORMATION PROCESSING METHOD FOR ELECTRONIC DEVICE WITH FACIAL RECOGNITION FUNCTION

(71) Applicant: Beijing Jinher Software Co., Ltd., Beijing (CN)

(72) Inventor: Runfeng LUAN, Beijing (CN)

(21) Appl. No.: 14/318,706

(22) Filed: Jun. 30, 2014

(30) Foreign Application Priority Data
Jun. 18, 2014 (CN) 201410273442.3

(51) Int. Cl. G06K 9/00; G06F 21/32

(52) U.S. Cl. CPC G06K 9/00288; G06K 9/00228; G06K 9/00604; G06K 9/00617; G06F 21/32

(57) ABSTRACT

The present invention discloses an information processing method for an electronic device with a facial recognition function, an information processing device for an electronic device with a facial recognition function, and an information processing method for an electronic device with an iris recognition function. The present invention detects a face or iris of an operating user, and determines whether it matches the facial image or iris image which is stored in the electronic device in advance. If it is determined that the face of the user who is operating the electronic device does not match the facial image stored in the electronic device, the user interface of the electronic device is switched to a user preset state. The present invention can effectively protect user's privacy.

### CROSS-REFERENCE TO RELATED APPLICATIONS

This application claims the priority benefit of Chinese application No. 201410273442.3, which was filed on Jun. 18, 2014. The entirety of the above-mentioned patent application is hereby incorporated by reference herein and made a part of specification.

### BACKGROUND OF THE INVENTION

1. Field of the Invention

The present invention relates to switching a user interface by means of facial recognition or iris recognition, and particularly to switching the user interface of a portable electronic device.

2. Background of the Invention

In the biological recognition technology, a smart device is combined with an optical, acoustic, or biological sensor, and with principle of biological statistics, to identify a personal identity by means of physiological characteristics and behavior characteristics which are inherent in a human body. The mostly widely applied biological feature recognition comprises fingerprint recognition, facial recognition, iris recognition or the like.

The electronic device, especially a portable device like a mobile phone, PAD, or the like, is playing more and more important role in the daily life. As a result, the security about these electronic devices is critical. Apple Inc. is a pioneer in employing a method for unlocking an electronic device by means of fingerprint recognition. However, in this method, the biological characteristics recognition technique has not been used to protect the client's privacy during operating the electronic device. When the user is running some private applications like Weibo, WeChat, or message on these electronic devices, some private information of the user may be seen via the screen by people other than the user, thus leaking the client's privacy. By combining the biological characteristics recognition with the portable electronic device, it is possible to significantly improve security of the portable electronic device.

### BRIEF SUMMARY OF THE INVENTION

The present invention develops an information processing method for an electronic device with a facial recognition function. The present invention combines the facial recognition or iris recognition with the user interface switching, and effectively guarantee the user's privacy.

The technical solutions of the present invention provide lie in the following aspects.

An information processing method for an electronic device with a facial recognition function comprises:

obtaining a facial image of a user, when the user is operating the electronic device;

maintaining an original state for the user interface of the electronic device, if the obtained facial image of the user matches a facial image stored in the electronic device; and

switching the user interface of the electronic device to a user preset state, if the obtained facial image of the user does not match the facial image stored in the electronic device.

Preferably, the present method comprises obtaining the facial image of the user, when the user is operating an instant messenger on the electronic device.

Preferably, the present method comprises obtaining the facial image of the user at a predefined interval, when the user is operating the electronic device, wherein the predefined interval is a value between 1 and 60 seconds.

Preferably, the present method comprises continuously obtaining the facial image of the user, when the user is operating the electronic device.

Preferably, in the present method, the user preset state is a user interface locking state.

Preferably, in the present method, the user preset state is a user interface black screen state.

An information processing device for an electronic device with a facial recognition function comprises:

a device for obtaining a facial image of the user when a user is operating the electronic device;

a device for maintaining an original state for the user interface of the electronic device, if the obtained facial image of the user matches a facial image stored in the electronic device; and

a device for switching the user interface of the electronic device to a user preset state, if the obtained facial image of the user does not match the facial image stored in the electronic device.

Preferably, in the present device, the facial image of the user is obtained, when the user is operating an instant messenger on the electronic device.

Preferably, in the present device, the facial image of the user is obtained at a predefined interval, when the user is operating the electronic device, wherein the predefined interval is a value between 1 and 60 seconds.

Preferably, in the present device, the facial image of the user is continuously obtained, when the user is operating the electronic device.

Preferably, in the present device, the user preset state is a user interface locking state.

Preferably, in the present device, the user preset state is a user interface black screen state.

An information processing method for an electronic device with an iris recognition function comprises:

obtaining an iris image of a user, when the user is operating the electronic device;

maintaining an original state for the user interface of the electronic device, if the obtained user iris image matches an iris image stored in the electronic device; and

switching the user interface of the electronic device to a user preset state, if the obtained user iris image does not match the iris image stored in the electronic device.

Preferably, the present method comprises obtaining the iris image of the user, when the user is operating an instant messenger on the electronic device.

Preferably, the present method comprises obtaining the iris image of the user at a predefined interval, when the user is operating the electronic device, wherein the predefined interval is a value between 1 and 60 seconds.

Preferably, the present method comprises continuously obtaining the iris image of the user, when the user is operating the electronic device.

Preferably, in the present method, the user preset state is a user interface locking state.

Preferably, in the present method, the user preset state is a user interface black screen state.

The present invention devises an information processing method for an electronic device with a facial recognition function, which integrates the facial recognition technique with the switching of the user interface, wherein when the user is operating the electronic device, the user interface can be switched automatically if the presence of people other than the user is detected, thus effectively protecting the user's privacy and the privacy of user's operations. The present invention devises an information processing device for an electronic device with a facial recognition function, which can detect the face of the user when the user is operating the electronic device, to determine whether the preset user is operating the electronic device, and can automatically switch the user interface upon detecting the presence of people other than the user, thus effectively protecting the user's privacy and the privacy of user's operations. The present invention devises an information processing method for an electronic device with an iris recognition function, which integrates the facial recognition technique with the switching of the user interface, wherein when the user is operating the electronic device, the user interface can be switched automatically if the presence of people other than the user is detected, thus effectively protecting the user's privacy and the privacy of user's operations.

### BRIEF DESCRIPTION OF THE DRAWINGS

FIG. 1 is a flowchart illustrating the switching of a user interface by means of facial recognition in the present invention.

FIG. 2 is a flowchart illustrating the switching of a user interface by means of iris recognition in the present invention.

### DETAILED DESCRIPTION OF THE INVENTION

The present invention will be described in detail hereinafter by referring to its embodiments, so that the skilled in the art can implement the present invention in accordance with the present disclosure.

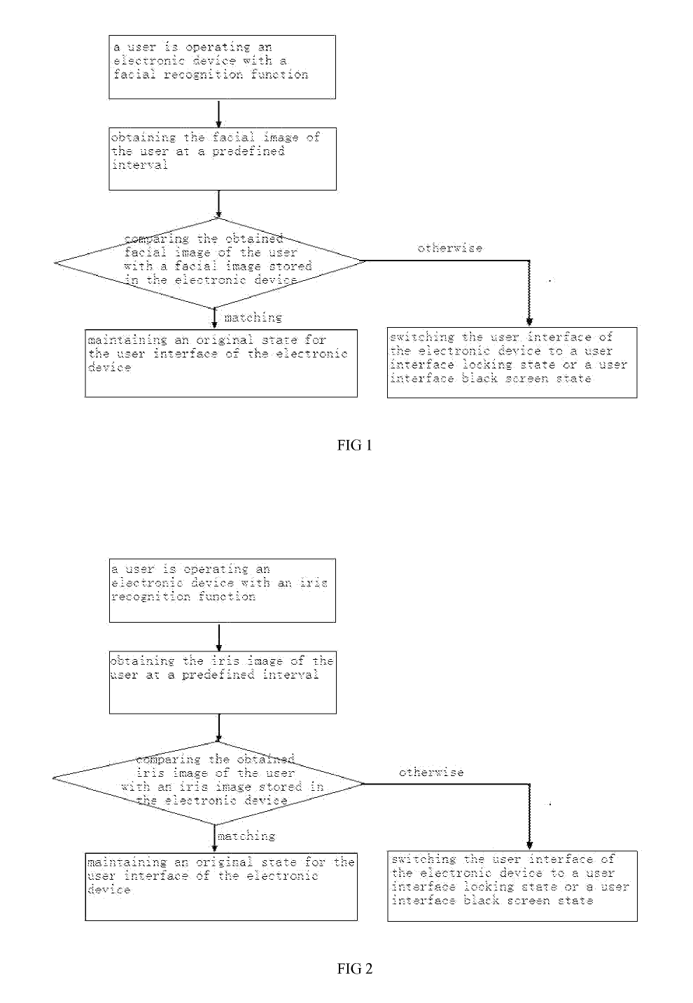

As shown in FIG. 1, an information processing method for an electronic device with a facial recognition function comprises:

obtaining at a predefined interval or continuously a facial image of the user; wherein the predefined interval is a value between 1 and 60 seconds, when the user is operating the electronic device or when the user is operating an instant messenger on the electronic device;

maintaining the original state for the user interface of the electronic device, when the obtained facial image of the user matches the facial image stored in the electronic device;

switching the user interface of the electronic device to a user preset state, when the obtained facial image of the user does not match the facial image stored in the electronic device, wherein the preset state may be a user interface locking state or a user interface black screen state.

The above mentioned electronic device with a facial recognition function can be a PDA (Personal Digital Assistant, also referred to as a pocket computer, including a smart mobile phone, a tablet computer, or the like), computer, etc. The smart mobile phone is taken as an example of this electronic device in this disclosure. The instant messenger is also called as chatting software. The popular instant messenger comprises QQ, WeChat, MSN, Anychat, or the like. WeChat is taken as an example of the instant messenger in this disclosure.

The application system of the smart mobile phone can be an Android system or an IOS system. The smart mobile phone is integrated with a front-facing camera with a resolution of no less than 200 MP.

An image for the front face of the user is stored in the smart mobile phone in advance.

When the user is running WeChat on the smart mobile phone, the user can select a time value between 1 and 60 seconds for taking a facial image of the user who is operating the smart mobile phone, or continuously taking facial images of the user who is operating the smart mobile phone. The smart mobile phone performs a matching operation between the taken facial image(s) of the user and the facial images stored in the smart mobile phone. If they math with each other, the smart mobile phone maintains the original state of the user interface; otherwise, the user interface of the smart mobile phone is automatically switched to a user interface locking state or a user interface black screen state. As for the method for comparing or matching facial images of the user and facial images stored in the smart mobile phone in this embodiment, any method for image comparing or matching which is known in the art can be applied.

As shown in FIG. 2, an information processing method for an electronic device with an iris recognition function comprises:

obtaining an iris image of the user at a predefined interval or continuously obtaining iris images of the user, when the user is operating an electronic device or running an instant messenger on the electronic device, wherein the predefined interval is a value between 1 and 60 seconds;

maintaining an original state for the user interface of the electronic device, if the obtained user iris image matches an iris image stored in the electronic device;

switching the user interface of the electronic device to a user preset state, if the obtained user iris image does not match the iris image stored in the electronic device; wherein the user preset state is a user interface locking state or a user interface black screen state.

The above mentioned electronic device with an iris recognition function can be a PDA (Personal Digital Assistant, also referred to as a pocket computer, including a smart mobile phone, a tablet computer, or the like), computer, etc. The tablet computer is taken as an example of this electronic device in this disclosure. The instant messenger is also called as chatting software. The popular instant messenger comprises QQ, WeChat, MSN, Anychat, or the like. QQ is taken as an example of the instant messenger in this disclosure.

The application system of the tablet computer can be an Android system, an IOS system, or a Windows system. The tablet computer is integrated with an iris scanning device.

An iris image for the user is stored in the tablet computer in advance.

When the user is running QQ on the tablet computer, the user can select a time value between 1 and 60 seconds for scanning an iris image of the user who is operating the tablet computer, or continuously scanning iris images of the user who is operating the tablet computer. The tablet computer performs a matching operation between the scanned iris image(s) of the user and the iris images stored in the tablet computer. If they math with each other, the tablet computer maintains the original state of the user interface; otherwise, the user interface of the tablet computer is automatically switched to a user interface locking state or a user interface black screen state. As for the method for comparing or matching iris images of the user and iris images stored in the tablet computer in this embodiment, any method for image comparing or matching which is known in the art can be applied.

An information processing device for an electronic device with a facial recognition function comprises:

a device for obtaining a facial image of a user at a predefined interval or continuously, when the user is operating an instant messenger on the electronic device, wherein the predefined interval is a value between 1 and 60 seconds;

a device for maintaining an original state for the user interface of the electronic device, if the obtained facial image of the user matches a facial image stored in the electronic device; and

a device for switching the user interface of the electronic device to a user interface locking state or a user interface black screen state, if the obtained facial image of the user does not match the facial image stored in the electronic device.

Although the present invention has been described above with reference to specific embodiments, it should be understood that the limitations of the described embodiments are merely for illustrative purpose and by no means limiting. Instead, the scope of the invention is defined by the appended claims rather than by the description, and all variations that fall within the range of the claims are intended to be embraced therein. Thus, other embodiments than the specific ones described above are equally possible within the scope of these appended claims.

1. An information processing method for an electronic device with a facial recognition function, characterized by comprising:
obtaining a facial image of a user, when the user is operating the electronic device;
maintaining an original state for the user interface of the electronic device, if the obtained facial image of the user matches a facial image stored in the electronic device; and
switching the user interface of the electronic device to a user preset state, if the obtained facial image of the user does not match the facial image stored in the electronic device.

2. The method of claim 1, characterized in that,
obtaining the facial image of the user, when the user is operating an instant messenger on the electronic device.

3. The method of claim 1, characterized in that,
obtaining the facial image of the user at a predefined interval, when the user is operating the electronic device, wherein the predefined interval is a value between 1 and 60 seconds.

4. The method of claim 1, characterized in that,
continuously obtaining the facial image of the user, when the user is operating the electronic device.

5. The method of claim 1, characterized in that,
the user preset state is a user interface locking state.

6. The method of claim 1, characterized in that,
the user preset state is a user interface black screen state.

7. An information processing device for an electronic device with a facial recognition function, characterized by comprising:
a device for obtaining a facial image of the user when a user is operating the electronic device;
a device for maintaining an original state for the user interface of the electronic device, if the obtained facial image of the user matches a facial image stored in the electronic device; and
a device for switching the user interface of the electronic device to a user preset state, if the obtained facial image of the user does not match the facial image stored in the electronic device.

8. The device of claim 7, characterized in that,
the facial image of the user is obtained, when the user is operating an instant messenger on the electronic device.

9. The device of claim 7, characterized in that,
the facial image of the user is obtained at a predefined interval, when the user is operating the electronic device, wherein the predefined interval is a value between 1 and 60 seconds.

10. The device of claim 7, characterized in that,
the facial image of the user is continuously obtained, when the user is operating the electronic device.

11. The device of claim 7, characterized in that,
the user preset state is a user interface locking state.

12. The device of claim 7, characterized in that,
the user preset state is a user interface black screen state.

13. An information processing method for an electronic device with an iris recognition function, characterized by comprising:
obtaining an iris image of a user, when the user is operating the electronic device;
maintaining an original state for the user interface of the electronic device, if the obtained user iris image matches an iris image stored in the electronic device; and
switching the user interface of the electronic device to a user preset state, if the obtained user iris image does not match the iris image stored in the electronic device.

14. The method of claim 13, characterized in that,
obtaining the iris image of the user, when the user is operating an instant messenger on the electronic device.

15. The method of claim 13, characterized in that,
obtaining the iris image of the user at a predefined interval, when the user is operating the electronic device, wherein the predefined interval is a value between 1 and 60 seconds.

16. The method of claim 13, characterized in that,
continuously obtaining the iris image of the user, when the user is operating the electronic device.

17. The method of claim 13, characterized in that,
the user preset state is a user interface locking state.

18. The method of claim 13, characterized in that,
the user preset state is a user interface black screen state.
